(19) United States
(12) Patent Application Publication
(10) Pub. No.: US 2003/0198765 A1
(43) Pub. Date: Oct. 23, 2003

(54) Process for making a metal-polymer composite having an irradiated and thermally adhered polymer coating

(76) Inventors: Thomas L. Levendusky, Greensburg, PA (US); Ronald G. Ankney, New Kensington, PA (US)

Correspondence Address: ALCOA INC, ALCOA TECHNICAL CENTER, 100 TECHNICAL DRIVE, ALCOA CENTER, PA, 15069-0001, US

(21) Appl. No.: 10/127,283

(22) Filed: Apr. 22, 2002

(51) Int. Cl. B32B 1/02

(52) U.S. Cl. 428/35.7

(57) ABSTRACT

A process for making a metal-polymer composites sheet suitable for shaping into container end panels having improved adhesion and water resistance. A polymer precurser coating is applied to a metal sheet. The polymer precurser coating is selected from the group consisting of epoxy acrylates, silicones, and polyester acrylates. The polymer precurser coating on the metal sheet is irradiated with ultraviolet or an electron beam energy to polymerize the coating and heated to adhere the polymer to the microsurface of the metal sheet.

### FIELD OF THE INVENTION

The present invention relates to a process for making a metal-polymer composite suitable for shaping into container end panels for food and beverage containers. More specifically, the invention relates to a metal-polymer composite having enhanced polymer coating adherence to the metal substrate in the composite.

### BACKGROUND OF THE INVENTION

Metal sheet coated with a thermosetting coating on one or more surfaces is commonly used for shaping into end panels for food and beverage containers. The coating can be applied by process such as reverse roll coating, gravure coating, electrocoating, spraying and forward roll coating. Coatings are applied to the metal sheet to improve preservation and taste characteristics of the food and beverages that will be stored in the metal containers produced from the sheet. Coatings also improve the corrosion resistance, formability and appearance of the metal.

Commonly used commercial coating processes involve the use of solvent based systems that generate volatile organic compounds (VOCs) into the air. To reduce or eliminate the generation of such volatile organics during the coating process, 100% solids coating systems can be applied to the metal surface during the coating process. Examples of 100% solids coating systems are those known as ultraviolet (UV) or electron beam (EB) curable coatings.

However, UV and EB curable coatings often separate from the metal substrate during end formation operations. High delamination rates waste materials, time and effort, thereby increasing costs to the container manufacturer.

Accordingly, a need exists for a polymer coated metal sheet which is produced using coatings that do not generate VOC's after being cured and which has sufficient polymer adhesion to adhere to the metal during subsequent fabrication of the metal sheet into ends for beverage or food containers.

Thus, an objective of the present invention is to provide a polymer coated metal sheet, and a method of making the same, which is produced using coatings that do not generate VOC's during curing and which has sufficient adhesive strength to adhere to the metal surface during subsequent fabrication of the metal sheet into ends for beverage or food containers.

Additional objectives and advantages of our invention will become apparent to persons skilled in the art from the following detailed description of some particularly preferred embodiments.

### SUMMARY OF THE INVENTION

The invention provides a process for making a metal-polymer composite sheet suitable for shaping into food and beverage container end panels, comprising coating a metal sheet with a radiation curable polymer precursor; irradiating the polymer precursor with radiant electron beam or ultraviolet radiation in an amount sufficient to polymerize and cross link the polymer precursor to form a metal-polymer composite; and heating the metal-polymer composite to enhance adhesion of the polymer to the metal.

The invention also provides a metal-polymer composite which is produced using coatings that do not generate VOC's during curing and which has sufficient adhesive strength to adhere to the metal surface during subsequent fabrication of the metal sheet into ends for beverage or food containers.

### DETAILED DESCRIPTION OF PREFERRED EMBODIMENTS

The invention provides a process for making a metal-polymer composite sheet suitable for shaping into food and beverage container end panels. The process comprises coating a metal sheet with a radiation curable polymer precursor; irradiating the polymer precursor with ultraviolet or electron beam radiation in an amount sufficient to polymerize and cross link the polymer precursor to form a metal-polymer composite sheet; and heating the metal-polymer composite sheet to adhere the polymer to the metal.

The metal sheet may comprise an aluminum alloy, steel, aluminum alloy-coated steel, or aluminum-coated steel. Aluminum alloy sheet is particularly preferred.

Aluminum alloys suitable for shaping into container bodies include aluminum-manganese alloys of the AA3000 series and aluminum-magnesium alloys of the AA5000 series. Aluminum alloys suitable for shaping into container end panels include aluminum-magnesium alloys of the AA3000 or AA5000 series and especially the AA5182 and AA5042 alloys.

Aluminum alloys suitable for container end panels such as AA5182 are provided as an ingot or billet or slab by casting. Before working, the ingot or billet is subjected to elevated temperature homogenization. The alloy stock is then hot rolled to provide an intermediate gauge sheet. For example, the material may be hot rolled at a metal entry temperature of about 700-950° F. to provide an intermediate product having a thickness of about 0.130 inch to about 0.190 inch. This material is cold rolled to provide a sheet ranging in thickness from about 0.007 to 0.014 inch A preferred metal sheet is AA5182 aluminum alloy sheet in either the H19 or H39 temper.

Aluminum alloys such as AA5042 are provided as an ingot that is homogenized. This procedure is followed by hot rolling to an intermediate gauge of about 0.125 inch. Typically, the intermediate gauge product is annealed, followed by cold rolling to a final gauge of about 0.007 to 0.014 inch. A preferred metal sheet is AA5042 aluminum alloy sheet in the H2E72 temper.

The aluminum alloy sheet is generally cleaned with an alkaline surface cleaner to remove any residual lubricant adhering to the surface, and then rinsed with water. Cleaning may be avoided if the residual lubricant content is negligible.

A conversion coating may also be applied to the sheet to assure good adhesion of the polymer coating and to improve corrosion resistance. Both chrome-containing and chrome-free conversion systems are suitable. The chrome conversion coating generally contains a chromate and a phosphate. Some non-chrome conversion coatings are solutions containing zirconate, titanate, molybdate, tungstate, vanadate, and silicate ions, generally in combination with hydrogen fluoride or other fluorides. The conversion coated sheet may be rinsed with water and then dried before a polymer coating is applied. Preferred conversion coatings include chromium phosphate pretreatments such as the A272 process available commercially from Alcoa Inc. or pretreatments consisting of co-polymers of vinyl phosphonic and acrylic acids such as the ALX009 coating available commercially from Alcoa Inc. described in U.S. Pat. No. 6,020,030 and U.S. Pat. No. 6,030,710.

The polymer is applied to the metal sheet as a radiation curable polymer precursor. Radiation curable polymer precursors are monomeric and/or oligimeric materials such as acrylics, methacrylates, epoxies, polyesters, polyols, glycols, silicones, urethanes, vinyl ethers and combinations thereof which have been modified to include functional groups and optionally photoinitiators that trigger polymerization upon the application of ultraviolet (UV) or electron beam (EB) radiant energy. Such polymer precursors include acrylated aliphatic oligomers, acrylated aromatic oligomers, acrylated epoxy monomers, acrylated epoxy oligomers, aliphatic epoxy acrylates, aliphatic urethane acrylates, aliphatic urethane methacrylates, allyl methacrylate, amine-modified oligoether acrylates, amine-modified polyether acrylates, aromatic acid acrylate, aromatic epoxy acrylates, aromatic urethane methacrylates, butylenes glycol acrylate, silanes, silicones, stearyl acrylate, cycloaliphatic epoxides, cyclohexyl methacrylate, ethylene glycol dimethacrylate, epoxy methacrylates, epoxy soy bean acrylates, glycidyl methacrylate, hexanediol dimethacrylate, isodecyl acrylate, isooctyl acrylate, oligoether acrylates, polybutadiene diacrylate, polyester acrylate monomers, polyester acrylate oligomers, polyethylene glycol dimethacrylate, stearyl methacrylate, triethylene glycol diacetate, and vinyl ethers.

The polymer coatings for use in this invention are thermosetting polymers that cross link and cure when exposed to suitable radiation sources.

The preferred polymer precursors are acrylated epoxy monomers and oligomers, polyester acrylates, and silicone monomers.

Photoinitiators suitable for use in this invention are materials which absorb UV and EB radiant energy and form reactive free radicals, cations or anions which initiate polymerization of monomeric and oligomeric materials. Such materials include acryloins, ketones, substituted benoquinones, substituted polynuclear quinones, halogenated aliphatic, alicyclic and aromatic hydrocarbons, and the like and mixtures thereof.

Photoinitiators may not be necessary for use with polymeric precursors that contain functional groups that are sufficiently reactive to polymerize upon irradiation with EB or UV radiation.

The most preferred polymer resins precurser systems are sold commercially by Sun Chemical Company of Fort Lee, N.J. under the trade designations Sunbeam and Suncure.

The polymer coating may also optionally contain additives such as dyes, pigment particles, anticorrosion agents, antioxidants, adhesion promoters, light stabilizers, lubricants, and mixtures thereof.

The polymer precurser coating may be applied to the sheet by any of several techniques, including gravure coating, slot coating, forward roll coating, reverse roll coating, spraying, and electrostatic coating. Reverse roll coating is particularly preferred. The polymer precurser coating is preferably applied onto the metal sheet as a single layer. Preferably, both sides of an aluminum alloy sheet are coated with a polymer precurser coating leaving a thickness of about 0.01-0.5 mils (1-13 microns).

To cure the polymer precurser coating, the aluminum-polymer composite sheet is irradiated with an electron beam. The electron beam polymerizes and cross links the coating. The radiation dose is about 2-20 megarads, preferably about 5-15 megarads. Electron beam radiation is the preferred energy for curing the polymer precurser coatings used for this invention, however, alternatively, UV radiation may also be used.

To enhance adherence of the cured polymer to the metal substrate the composite sheet is then heated by convection or induction heating to temperatures between 350-450 F. The exposure time needed for this heating step will depend upon the thickness of the substrate and coating, and the speed at which the composite (e.g., coil stock) traverses through the convection or induction heating units. A typical exposure time may range from 10-15 seconds.

The inventors believe the polymer precurser coating applied to the metal sheet is sufficiently viscous to bridge peaks in the irregular microsurface of the metal sheet. When the precurser coating is polymerized by radiant energy, the polymer networks across the metal surface peaks. By networking across the peaks, the polymer does not adhere as strongly to the metal than if the polymer inhabited the pockets, grooves, and other features of the metal microsurface. Heating of the metal-polymer composite sheet causes the polymer to flow into the metal surface irregularities. Upon cooling of the sheet polymer hardens within the irregularities in the metal surface thereby increasing the strength of the polymer adherence to the metal sheet.

The irradiated and heat treated composites sheets are shaped into container end panels for food and beverage containers. Easy open end panels for carbonated beverages are generally shaped by stamping metal blanks between shaping dies.

In the preferred embodiment of the invention, sheets of metal coated with a polymer precurser are exposed to EB radiation and heated before the sheets are formed into container ends. However, heating of a metal sheet coated with a polymer precurser prior to irradiation with EB energy is also within the scope of this invention. Also, sheets of metal coated with a polymer precurser can be exposed to EB radiation, formed into container ends and heated within the scope of this invention.

The invention will now be further described with reference to a number of specific examples which are to be regarded solely as illustrative and not as restricting the scope of the present invention.

### EXAMPLES

In accordance with the present invention an AA5182 aluminum alloy sheet in the H19 temper having a sheet thickness of about 0.0080-0.0090 in (0.20-0.23 mm) is cleaned with an alkaline surface cleaner to remove residual surface lubricant, and rinsed. The cleaned sheet is then conversion coated with an aqueous solution containing chromate and phosphate ions, rinsed again, and dried.

The roll coating apparatus applies to the aluminum sheet a coating of a polymer precurser having a thickness of approximately 0.0001-0.0005 in (2.5-13 microns).

The polymer coating in the composite is irradiated by an electron beam. A suitable electron beam generator is commercially available from Energy Sciences, Inc. of Wilmingon, Mass. under the trade designation ESI “ELECTROCURE” EB SYSTEM.

Half of the samples are subjected to thermal or induction heating by raising the metal temperature to a range of 350-450 F, cooled (preferably with water) and dried.

Examples of the improvement in performance, particularly the adhesion before and after water pasteurization testing (immersed for 30 min @ 180 F), are summarized in Tables 1 & 2. Table 1 shows the results of testing on samples that were not subjected to heat treatment after curing. Table 1 details the poor adhesion (i.e., pickoff with Scotch 610 tape) and water sensitivity of both the UV cured and EB-cured coatings, each of which were applied to three different surfaces on 5182-H19 alloy. The A685 treatment is an alkaline carbonate cleaner, the A272 is a chrome phosphate pretreatment, and ALX009 is a non-chrome pretreatment. Table 2 depicts the improvement in adhesion for both the dry and wet (i.e., water pasteurization) conditions as a result of the invention heat treatment.

TABLE 1
Test Results on Radiation-Cured Coatings from Sun Chemical Company

| | Metal | | Enamel Rate | | |
|---|---|---|---|---|---|
| Coating | Treatment | Dry Adhesion | (ma) | Comments | Coating Type |
| SUNBEAM | A685 | Pickoff | 315 | H₂O sensitive | E-beam |
| SUNBEAM | A272 | Pickoff | 393 | H₂O sensitive | E-beam |
| SUNBEAM | ALX 009 | Pickoff | 160 | H₂O sensitive | E-beam |
| SUNCURE | A685 | Pickoff | 259 | H₂O sensitive | UV |
| SUNCURE | A272 | Pickoff | 322 | H₂O sensitive | UV |
| SUNCURE | ALX 009 | Pickoff | 382 | H₂O sensitive | UV |

TABLE 2
Test Results on Two-Step Cured Coatings (Radiation + Thermal)

| | | Dry | Water | |
|---|---|---|---|---|
| Coating | Metal | Adhesion | Pasteurization | Heat Resistance |
| SUNBEAM | A685 | 100% | 88% Adhesion | >500° F. |
| SUNBEAM | A272 | 100% | 99% Adhesion | >500° F. |
| SUNBEAM | ALX 009 | 100% | 96% Adhesion | >500° F. |
| SUNCURE | A685 | 100% | 98% Adhesion | >500° F. |
| SUNCURE | A272 | 100% | 99% Adhesion | >500° F. |
| SUNCURE | ALX 009 | 100% | 99% Adhesion | >500° F. |

The foregoing disclosure of our invention has been made with reference to some particularly preferred embodiments. Persons skilled in the art will understand that numerous changes and modifications can be made without departing from the spirit and scope of the following claims.

What is claimed is:

1. A process for making a metal-polymer composite sheet suitable for shaping into food and beverage container end panels, comprising:
(a) coating a metal sheet with a radiation curable polymer precurser;
(b) irradiating said polymer precurser with ultraviolet or electron beam radiation in an amount sufficient to polymerize said polymer precurser to form a metal-polymer composite; and
(c) heating said metal-polymer composite to adhere said polymer to said metal.

2. The process of claim 1 wherein aid resin precurser is selected from the group consisting of acrylated epoxy, polyester acrylates, and silicones and wherein said radiation is electron beam radiation.

3. The process of claim 1 wherein aid resin precurser is selected from the group consisting of acrylated epoxy, polyester acrylates and silicones, and wherein said radiation is ultraviolet radiation.

4. The process of claim 1 wherein said metal sheet comprises a metal selected from the group consisting of aluminum alloys, steel, aluminum alloy-coated steel, and aluminum-coated steel.

5. The process of claim 1 wherein said metal sheet comprises an aluminum alloy of the AA3000 or AA5000 series.

6. The process of claim 1 wherein said metal sheet is selected from the group consisting of AA5182 and AA 5042.

7. The process of claim 1 wherein the step of applying the polymer coating to the metal sheet comprises, gravure coating, forward roll coating, electro coating or reverse roll coating.

8. The process of claim 1 wherein the step of irradiating comprises irradiating at a dosage of about 2-20 megarads.

9. The process of claim 1 further comprising:
(d) shaping said composite into a container end panel.

10. The process of claim 1 wherein step (c) is performed before step (b).

11. The process of claim 9 wherein step (c) is preformed after step (d).

12. The process of claim 1 wherein said metal sheet has a conversion coating on at least a portion of the metal sheet surface.

13. A process for making a aluminum alloy-polymer composite sheet suitable for shaping into food and beverage container end panels, comprising:
(a) coating an aluminum alloy sheet with about a 1-13 microns thick layer of a radiation curable thermosetting polymer precurser;
(b) irradiating said polymer precurser with about 2-20 mrads of electron beam radiation to polymerize said polymer precurser to form an aluminum alloy metal-polymer composite; and
(c) heating said aluminum alloy-polymer composite to adhere said polymer to said metal.

14. A metal-polymer composite sheet suitable for shaping into food or beverage container end panels comprising an aluminum alloy sheet coated with a thermosetting polymer, said polymer polymerized by electron beam radiation and thermally adhered to said aluminum alloy sheet.

15. The metal-polymer composite sheet of claim 14 wherein said thermosetting polymer coating is 1-13 microns thick and is selected from the group consisting of epoxy acrylates, silicones, and polyester acrylates.

16. An aluminum alloy-polymer composite container comprising an exterior aluminum alloy shell and an interior polymeric coating polymerized on said shell and thermally adhered to said shell.
